(19) United States
(12) Patent Application Publication
(10) Pub. No.: US 2022/0069675 A1
(43) Pub. Date: Mar. 3, 2022

(54) STATOR AND ELECTRIC MACHINE

(71) Applicant: JHEECO E-DRIVE AG, Eschen (LI)

(72) Inventors: Martin STÖCK, Salez (CH); Pèter PÁDÁR, Budapest (HU)

(21) Appl. No.: 17/413,410

(22) PCT Filed: Dec. 11, 2019
(86) PCT No.: PCT/EP2019/084750

§ 371 Date: Jun. 11, 2021

(30) Foreign Application Priority Data
Dec. 12, 2018 (DE) 10 2018 131 973.8

(51) Int. Cl. H02K 11/25; H02K 3/50

(52) U.S. Cl. CPC H02K 11/25; H02K 3/50

(57) ABSTRACT

The invention relates to a stator comprising at least one insulating disk, at least one interconnection web, and at least one temperature sensor, where
the insulation disk comprises a holding element and the interconnection web comprises an abutment surface for the temperature sensor,
the interconnection web and the temperature sensor are arranged and held at least in sections in the holding element and
the temperature sensor touches the abutment surface at least in part in a planar manner and is pressed against the abutment surface by a spring force and/or by a clamping force.

The invention relates to a stator and an electric machine.

An electrical connection component for a start/stop generator is known From CN 205792061 U and comprises a temperature measuring component with a temperature sensor. The temperature sensor is arranged in a bore extending into the temperature measuring component and is arranged releasably in the bore and is connected to the hole wall of the bore in a thermally conductive manner.

The effectively conductive current conductor cross section is reduced by the bore. This increases the electrical resistance in the temperature measurement region. This leads to a locally higher temperature than in the remainder of the conductor, which leads to falsification of the temperature values measured.

A stator with a hairpin winding is described in WO 2017/118786. The winding has neutral points. The stator comprises a connector that connects the neutral points of the winding to one another. The connector is arranged on a face-side end region of the winding. A temperature sensor for measuring and regulating the stator temperature is arranged on the connector.

The sensor has no direct contact with the winding, but is arranged on the connector. The heat from the winding must first be transferred to the connector. This entails a longer response time for the sensor. Since the sensor is positioned on the connector, it is not possible to measure the temperature of a phase at different points.

JP 2012-175816 A describes a temperature sensor for an electric motor with an oil-cooled end winding. The temperature sensor is arranged in a housing to protect it from the oil and is thus encapsulated from the external surrounding.

No abutment surface with a current-carrying conductor having a defined contact pressure is described for this temperature sensor. The heat transfer and therefore the measured values, however, depend largely on the contact pressure. Different or random pressing forces can therefore lead to strongly diverging measurement results for electric motors of the same design.

The invention is therefore based on the object of specifying a stator on which a temperature sensor is arranged in such a way that precise and timely temperature measurement is possible. The invention is furthermore based on the object of specifying an electric machine.

According to the invention, the object is satisfied with regard to the stator by the object of claim 1 and the electric machine by the object of claim 13.

The object is specifically satisfied by a stator comprising at least one insulation disk, at least one interconnection web, and at least one temperature sensor. The insulation disk comprises a holding element and the interconnection web comprises an abutment surface for the temperature sensor. The interconnection web and the temperature sensor are arranged and held at least in sections in the holding element. The temperature sensor touches the abutment surface at least in part in a planar manner and is pressed against the abutment surface by a spring force and/or by a clamping force.

The temperature sensor is arranged on an interconnection web, in particular an interconnection web made of copper, of a composite winding and is pressed against the interconnection web with a defined pressing and/or clamping force. The contact pressure enables better heat transfer to the temperature sensor.

Due to the defined or preset pressing force, firstly, more precise temperature measurement is possible and, secondly, diverging measurement results are prevented for electric motors of the same design. Furthermore, by arranging the sensor directly on the conductor, a shorter response time is possible than with other measuring methods. It is possible to operate electric motors closer to the temperature limit due to the lower measurement inaccuracies and shorter response time.

Preferred embodiments of the invention are specified in the dependent claims.

In a preferred embodiment, the holding element is U-shaped in cross section with a base, a first side wall, and a second side wall between which the interconnection web and the temperature sensor are arranged. As a result, the temperature sensor can be arranged directly on an interconnection web. The holding element is preferably integrated into the insulating disk or formed as an integral part with the insulating disk.

In a further preferred embodiment, the interconnection web is supported directly or indirectly on the first side wall, and the temperature sensor is supported directly or indirectly on the second side wall. This is advantageous for a close and planar arrangement of the temperature sensor on the interconnection web.

It is advantageous to have the base or a side wall comprise a spacer for the temperature sensor. This reduces disruptive temperature influences and thereby increases the accuracy of the temperature measurement.

The second side wall and/or the interconnection web is advantageously resiliently deformable. This makes it possible to hold or attach the temperature sensor and the interconnection web in the holding element by clamping. For this purpose, it is advantageous to have the interconnection web be configured as a spring element, in particular as a V-shaped spring element. Other types of springs are conceivable. In particular, a bending stress can also be used to apply a spring force by bending the interconnection web along its longitudinal axis. Alternatively, the second side wall can have an inclination in the direction of the first side wall before the temperature sensor is installed. In the installed state, the temperature sensor pushes the second side wall outwardly, the latter thereby assuming an approximately right-angled position. The second side wall strives back to its inclined position and thereby exerts a restoring force upon the temperature sensor which presses the temperature sensor against the abutment surface of the interconnection web.

Further advantageously, the distance in cross section of the holding element between the second side wall and the interconnection web prior to the installation of the temperature sensor is smaller than the width of the temperature sensor. This is advantageous for the adhesion or the clamping force between the interconnection web and the temperature sensor.

The second side wall advantageously has a retaining profile that holds the temperature sensor in the holding body. The retaining profile is configured, for example, as extensions oriented in the direction of the base of the holding element. The extensions project from the second side wall at an acute angle, where the angle is open in the direction of the base. On the one hand, the retaining profile presses the temperature sensor against the interconnection web and, on the other hand, prevents movement in the direction of the open side of the holding element. The temperature sensor is thus secured against slipping away due to impacts or vibrations. The temperature sensor can have a retention profile.

In an advantageous embodiment, at least one spring pressing the temperature sensor against the interconnection web is arranged between the second side wall and the temperature sensor. The spring is formed to be, for example, V-shaped. Other types of springs or spring geometries are conceivable. The pressing force can be adapted by varying the spring constant of the spring used.

Advantageously, at least one movable pressing element is integrated into the second side wall and acted upon by a force in the direction of the temperature sensor. This enables the assembly without additional attachment elements.

Furthermore, the interconnection web can be fluid-cooled, in particular have oil flow around it. Due to the defined pressing force and the abutment surface, no or hardly any cooling fluid flows between the interconnection web and the temperature sensor. Distortion of the temperature measurement can then be prevented. The holding element is advantageously adapted in cross section over the length of the abutment surface in such a way that a constant fluid flow can be maintained in comparison with a section of the fluid-cooled interconnection web disposed upstream or downstream. In a further embodiment, the second side wall is formed to be wedge-shaped. It is advantageous to have the second side wall abut directly against the temperature sensor. Alternatively, it is advantageous to have a pressing wedge be arranged between the second side wall and the temperature sensor. Due to the wedge shape, the temperature sensor is held in a force-locking manner between the interconnection web and the second side wall in both cases.

An electric machine is furthermore disclosed and claimed in the context of the invention.

The invention shall be explained using several embodiments with reference to the accompanying schematic drawings providing further details,

where:

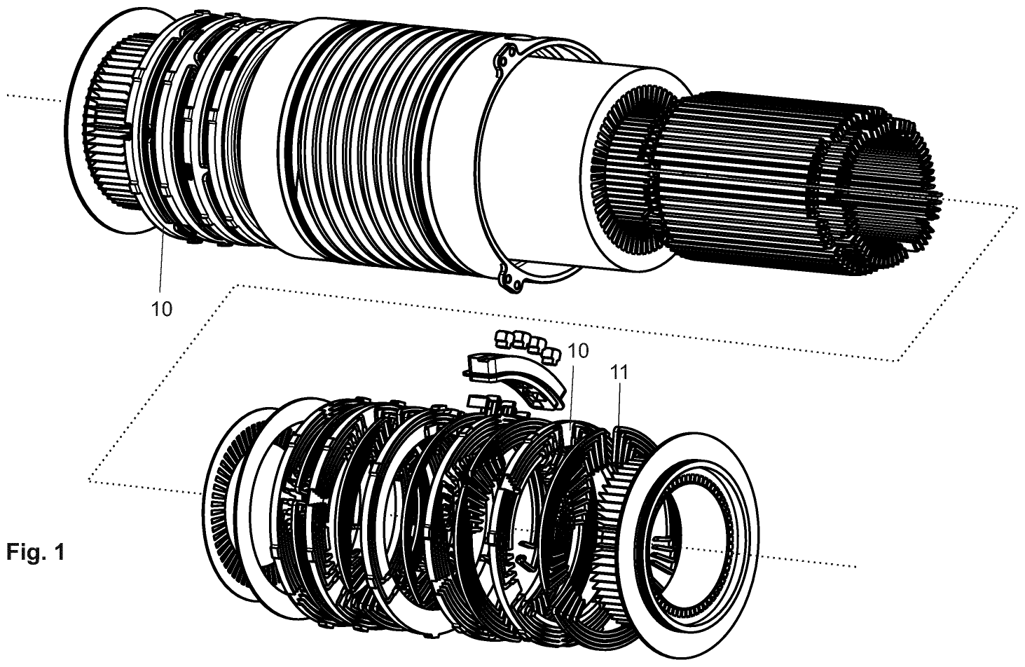

FIG. 1 shows a perspective illustration of an embodiment according to the invention of a stator,

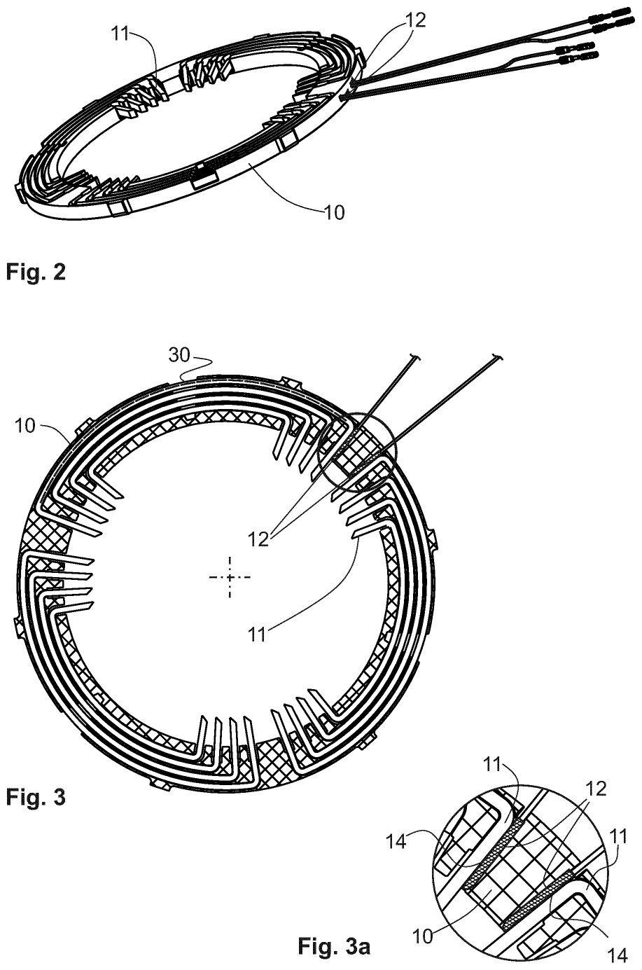

FIG. 2 shows a perspective illustration of an embodiment according to the invention of an interconnection plane with a temperature sensor,

FIG. 3 shows a perspective top view of an embodiment according to the invention of an arrangement of a temperature sensor in an interconnection plane,

FIG. 3a shows a detailed view of the arrangement of the temperature sensor from FIG. 3,

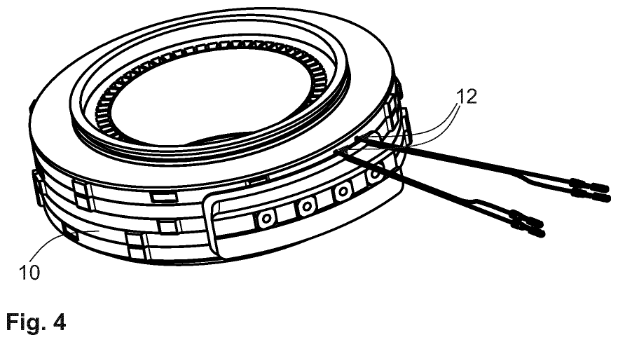

FIG. 4 shows a perspective view of a temperature sensor in the assembled state,

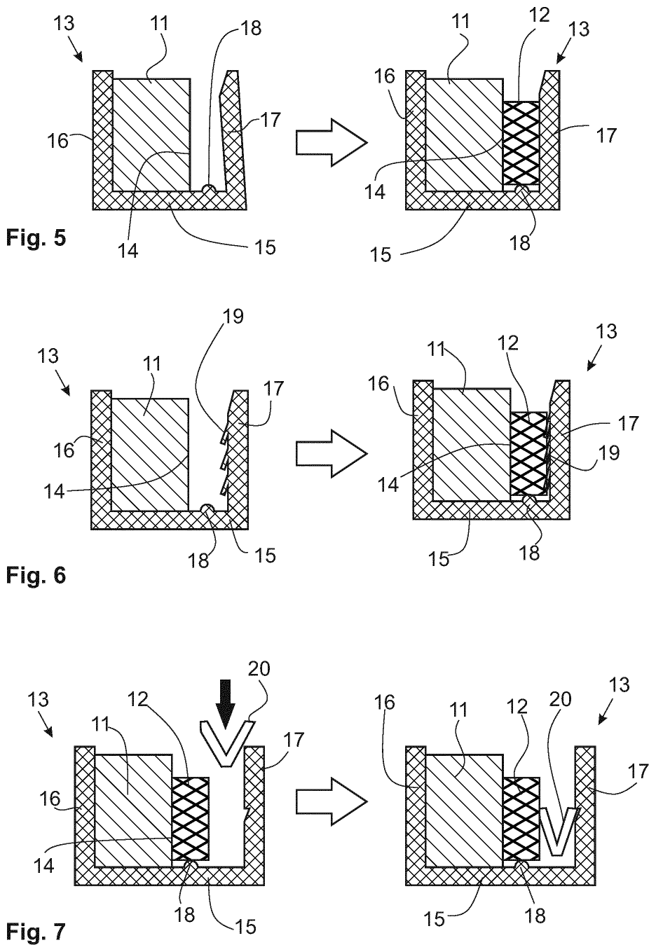

FIG. 5 shows a cross section of an embodiment according to the invention of a holding element with a resiliently deformable second side wall,

FIG. 6 shows a cross section of an embodiment according to the invention of a holding element with a retaining profile,

FIG. 7 shows a cross section of an embodiment according to the invention of a holding element with a spring,

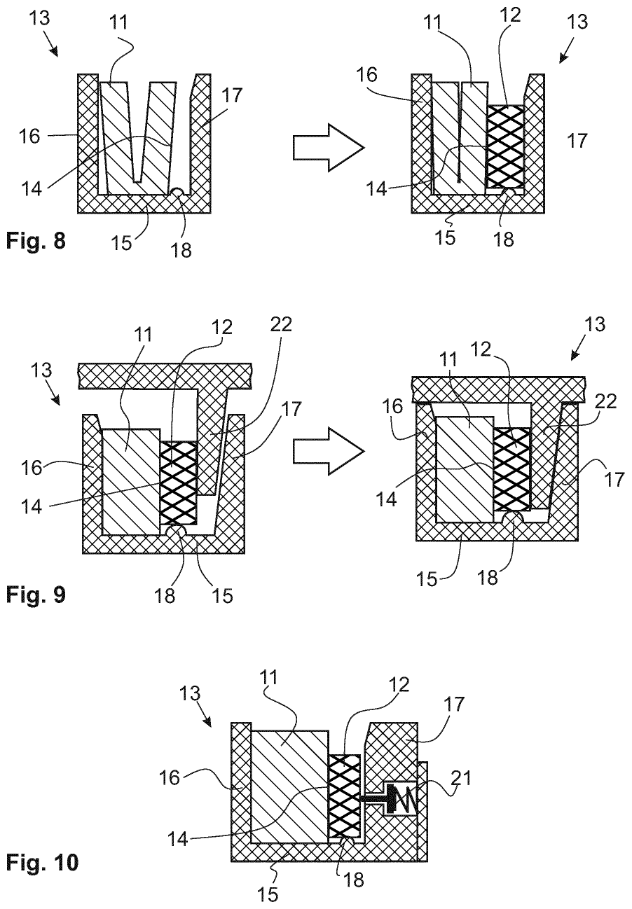

FIG. 8 shows a cross section of an embodiment according to the invention of a holding element with a resiliently deformable interconnection web,

FIG. 9 shows a cross section of an embodiment according to the invention of a holding element with a wedge-shaped second side wall,

FIG. 10 shows a cross section of an embodiment according to the invention of a holding element with a pressing element integrated into the second side wall,

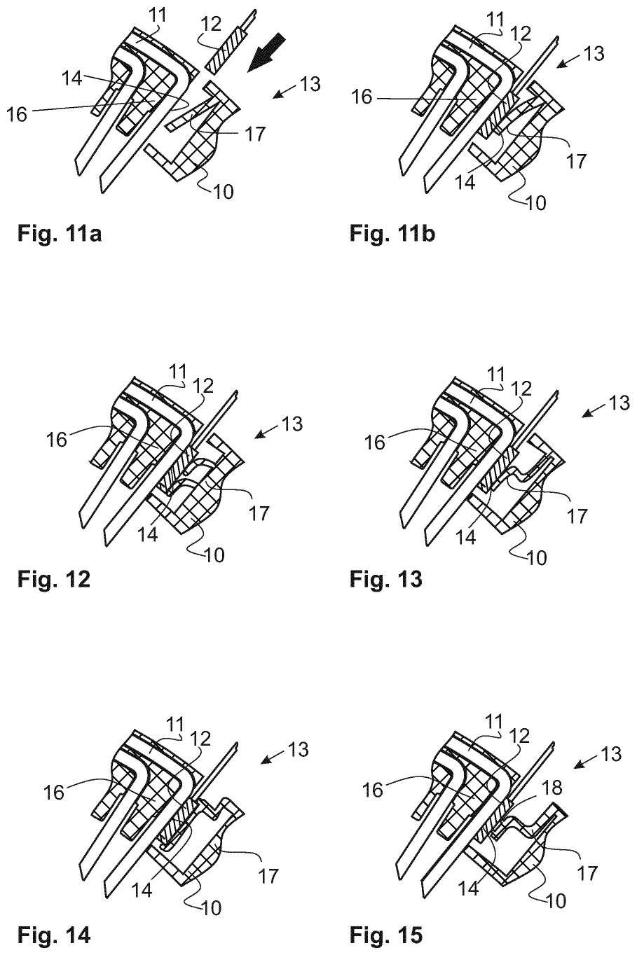

FIGS. 11a-b show a cross section of an embodiment according to the invention of a holding element with a resilient side wall,

FIG. 12 show a cross section of an embodiment according to the invention of a holding element with a resilient side wall,

FIG. 13 show a cross section of an embodiment according to the invention of a holding element with a resilient side wall,

FIG. 14 show a top view of an embodiment according to the invention of a holding element with a resilient side wall and a temperature sensor clipped in,

FIG. 15 show a top view of an embodiment according to the invention of a holding element with a resilient side wall with spacers,

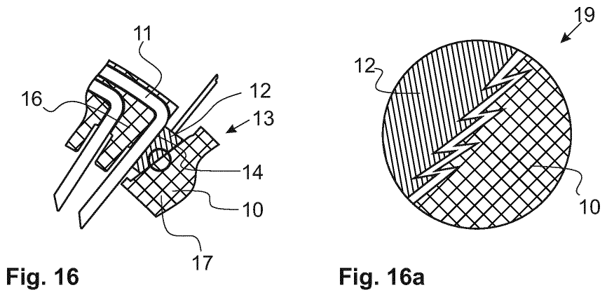

FIG. 16 shows a top view of an embodiment according to the invention of a holding element with a wedge-shaped temperature sensor,

FIG. 16a shows a partial section from FIG. 16 with a sawtooth-like retaining profile in the temperature sensor and the interconnection web.

Figure shows an embodiment according to the invention of a stator with a temperature sensor (not shown), The stator shown is suitable for generating a rotating magnetic field for asynchronous machines as well as for synchronous machines. The stator comprises an insulator ring, a laminated stator core, a composite winding with rod conductors, a housing, and two winding heads, where one winding head each is arranged at one axial end of the stator. The region projecting axially beyond the stator is referred to as the winding head.

The winding head shown in FIG. 1 comprises rod conductors, interconnection webs 11, insulating disks 10, a temperature sensor 12 (not shown), a sealing mat, and an insulator ring.

Rod conductors 21 are to be understood as being, in particular, hairpins and I-pins. Rod conductors can be formed integrally as a solid conductor or in several pieces, in particular as compression-molded wire strands. The rod conductors can be connected or connectable directly (bent towards one another and welded) or indirectly (by way of end connectors/interconnection webs).

FIG. 2 by way of example shows an arrangement of two temperature sensors 12 in an interconnection plane. The interconnection plane comprises an insulation disk 10 configured as an annular disk and C-shaped interconnection webs 11 made of copper.

Interconnection webs 11 are arranged in corresponding recesses in insulation disk 10. Interconnection webs 11 run parallel in part to the circumference of the insulation disk 10, where the end regions each extend radially inwardly. The interconnection webs can be inserted, braced along their longitudinal axis 30, into the recesses of the insulation disk.

FIG. 3 shows a top view of the interconnection plane described in FIG. 2. Temperature sensors 12 are arranged on the radially outermost interconnection webs 11 of two adjacent windings. Temperature sensors 12 are there each arranged on one of the radially inwardly oriented regions of interconnection webs 11.

FIG. 3a is a detailed view of a region from FIG. 3. The detailed view relates to the arrangement of temperature sensors 12. Temperature sensors 12 are arranged together with interconnection webs 11 in a holding element 13, i.e. a recess in the insulation disk 10. This arrangement is suitable due to the available accessibility from radially outside if, for example, axial accessibility for assembly is not given. Temperature sensors 12 can be inserted for assembly from axially above. Temperature sensors 12, however, can also be inserted or pushed in from radially outside. A different position of the sensor along an interconnection web 11 is conceivable. Different types and shapes of the temperature sensors are conceivable. Thermocouple elements as well as PTC and NTC thermistors are conceivable. The temperature sensors can be configured to be flat, circular or cylindrical. Interconnection webs 11 each comprise an abutment surface 14 onto which temperature sensors 12 are pressed. Side surfaces of interconnection webs 11 are selected as abutment surfaces 14. A different abutment surface 14, for example, an upper side or an underside, would likewise be conceivable. Temperature sensors 12 are connected to sensor cables. The sensor cables extend radially outwardly through an opening on the outer surface of insulation disk 10. The structure described above enables temperature sensor 12 to be arranged directly on a connection web 11, i.e. the temperature sensor is in contact with connection web 11. This increases the accuracy of the values measured and at the same time reduces the response time of the temperature sensor. Since holding element 13 is integrated into insulation disk 10, only a few or no additional components are required for installation.

FIG. 4 shows the interconnection plane according to FIG. 3 in the assembled state. The assembly shown comprises the insulator ring, five stacked insulation disks 10, interconnection webs 11, and temperature sensors 12. The position of temperature sensors 12 can be seen on the sensor cables.

In FIGS. 5 to 10, cross sections of different embodiments of holding element 13 are shown, where it is possible in principle to consider radial or axial assembly of temperature sensors 12. FIGS. 5 to 9 there each comprise two illustrations depicting different assembly steps.

FIG. 5 shows a cross section of a holding element 13. Holding element 13 is formed to be U-shaped in cross section. Holding element 13 comprises a first and a second side wall 16, 17 as well as a base 15. Second side wall 17 is configured to be resiliently deformable and comprises an inclination in the direction of first side wall 16.

A connection web 11 is arranged on first side wall 16 of holding element 13. Interconnection web 11 comprises an abutment surface 14 on the side facing second side wall 17. In the assembled state, a temperature sensor 12 is arranged between abutment surface 14 and second side wall 17. Base 15 comprises a spacer 18 in the region in which temperature sensor 12 is arranged in the assembled state.

Temperature sensor 12 presses second side wall 17 outwardly in the assembled state. This means that resiliently deformable second side wall 17 is not inclined inwardly in the assembled state, but rather assumes an approximately right-angle position. Second side wall 17 strives back to the original inclined position and exerts a restoring force upon temperature sensor 12.

The restoring force provided by resiliently deformable second side wall 17 entails a uniform, defined, and reproducible pressing force upon the temperature sensor.

FIG. 6 shows a further embodiment. Except for the configuration of second side wall 17 of holding element 13, the example corresponds substantially to the example described in FIG. 5.

Second side wall 17 shown in FIG. 6 has a retaining profile 19. Retaining profile 19 is configured as extensions oriented in the direction toward the base on the inner surface of second side wall 17. The extensions form an acute angle with the inner surface of second side wall 17 which is open in the direction of base 15.

In the installed state, the extensions rest against second side wall 17 or are pressed thereagainst. The extensions forming the retaining profile exert a restoring force upon temperature sensor 12 and press it against abutment surface 14.

Retaining profile 19, firstly, enables a predefined pressing force upon temperature sensor 12 and, secondly, the extensions directed in the direction of the base prevent temperature sensor 12 from moving in the direction of the open end of U-shaped holding element 13.

FIG. 7 describes a further embodiment. With the exception of second side wall 17, the structure of the example described hereafter corresponds substantially to the embodiment described in FIG. 5.

A spring 20 is arranged between temperature sensor 12 and the inner surface of second side wall 17. Spring 20 is V-shaped in cross section. In the assembled state, the closed side of V-shaped spring 20 points in the direction of base 15. The leg of spring 20 facing temperature sensor 12 comprises a flattening in the region that is in contact with the temperature sensor when installed. The flattened region serves to prevent damaging temperature sensor 12 and to apply a uniform, planar pressing force.

Temperature sensor 12 is acted upon by spring 20 with a defined restoring force which presses temperature sensor 12 against abutment surface 14 of interconnection web 12. For receiving spring 20 between temperature sensor 12 and second side wall 17, it is advantageous to have holding element 13 be formed to be wider in cross section than holding elements 13 described above.

Second side wall 17 comprises a notch on the inner surface. In the assembled state, the non-flattened spring leg is locked into this notch. As a result, spring 20 is held in position and secured against slipping away due to impacts or vibrations.

Holding element 13 shown in FIG. 8 corresponds substantially to holding element 13 described in FIG. 5.

Interconnection web 11 shown in FIG. 8 is formed to be V-shaped at least in sections and resiliently deformable. If temperature sensor 12 is arranged on abutment surface 14 of interconnection web 11, then the legs of interconnection web 11 are pressed together in such a way that the inner sides of the legs are in contact with one another.

Interconnection web 11 forms a spring element and acts upon temperature sensor 12 with a restoring force.

The change in the electrical resistance in the assembled state is minor in the region of V-shaped interconnection web 11. The legs of interconnection web 11 in the installed state are pressed together in such a way that the current conductor cross section approximately rectangular corresponds substantially to the conductor cross section of the non-V-shaped regions of interconnection web 11.

Interconnection web 11 is formed to be V-shaped in sections and is dimensioned such that the conductor cross section and/or the electrical resistance in the assembled or compressed state corresponds to the conductor cross section and/or the electrical resistance of the non-V-shaped sections of interconnection web 11.

In a further embodiment, not shown, the interconnection web could also be slotted in sections and provided with a bulge so that the interconnection web thus configured as a spring applies a force component that acts only in the horizontal direction for bracing a temperature sensor.

Furthermore, the interconnection web—similar to a bending beam—could be stressed to bend along its longitudinal axis 30, cf. FIG. 3, in particular by resilient deformation or reduction of the radius of a c-shaped, switched-off arc of an interconnection web 11 in order to brace a temperature sensor in the holding element 13. FIG. 9 shows an embodiment with a wedge-shaped second side wall 17. A pressing wedge 22 is arranged between temperature sensor 12 and second side wall 17. Pressing wedge 22 is arranged on the underside of an insulation disk 10 of a further interconnection plane.

Pressing wedge 22 interacts with wedge-shaped second side wall 17 in such a way that temperature sensor 12 and interconnection web 11 are acted upon by a pressing force.

FIG. 10 describes a holding element 13 with a second side wall 17 into which a movable pressing element 21 is integrated. Pressing element 21 comprises a spring element with an extension, for example, a pin or a bolt, which acts upon temperature sensor 12 with the restoring force of the spring element.

Integrated pressing element 21 enables quick assembly without any further loose components. As a result of the restoring force, temperature sensor 12 is pressed against interconnection web 11 with a uniform contact pressure.

FIGS. 11-16 show further embodiments of the invention that are particularly suitable for the radial assembly of temperature sensor 12 in holding element 13. FIGS. 11 to 16 each show a top view. FIGS. 11a, 11b show a temperature sensor before and after assembly. The assembly is carried out in the radial direction. Holding element 13 comprises two side walls 16, 17 similar to the other embodiments. Side wall 17 is configured as a resilient tongue which is configured as an integral appendix of an insulation disk 10. A connection web 11 is positioned with an abutment surface 14 between these side walls 16, 17, where side wall 17 is resiliently deformed when temperature sensor 12 is inserted. The illustration of base 15 has been omitted in these and subsequent figures.

FIGS. 12 to 16 show further variants of the invention, where only the essential differences from FIG. 11 shall be discussed.

FIG. 12 shows an embodiment of side wall 17 with two laterally projecting resilient tongues. As a result, the temperature sensor can be acted upon by two pressing forces. This increases the quality of the pressing.

FIG. 13 shows an embodiment of side wall 17 as an S-shaped tongue. In this way, for example, a force-distance profile can be better controlled or a spring characteristic profile can advantageously be set by way of the configuration of the S-shaped tongue.

FIG. 14 shows an embodiment of side wall 17 with a resilient extension. The extension is configured as a clip with at least two stop elements for receiving temperature sensor 12. During assembly, temperature sensor 12 engages in the stop elements so that a lock, in particular against displacement in the radial direction, is created.

FIG. 15 shows an embodiment of side wall 17 as a resilient tongue presently with two spacers 18. Instead of a surface contact, approximately two line contacts between the temperature sensor 12 and the side wall are thereby present between spacers 18 and temperature sensor 12, so that the controllability of the pressing force increases.

In FIG. 16, side wall 17 and temperature sensor 12 are each formed to be wedge-shaped. A pressing force can be increased in particular by bending interconnection web 11 along its longitudinal axis.

FIG. 16a shows a detail from FIG. 16. A surface contact between temperature sensor 12 and side wall 17 is shown, where the surfaces are each configured in a sawtooth-shaped manner. Holding element(s) 19 thus configured restrict the movability of temperature sensor 12 opposite to its assembly direction and prevent temperature sensor 12 from being pulled out and/or from becoming detached due to vibrations, for example, due to tension on the sensor cables.

In order to achieve a defined surface pressure between temperature sensor 12 and the interconnection web, it is generally conceivable that two or more of the above-mentioned variants are combined.

### List of Reference Characters

10 insulation disk

11 interconnection web

12 temperature sensor

13 holding element

14 abutment surface

15 base

16 first side wall

17 second side wall

18 spacer

19 retaining profile

20 spring

21 pressing element

22 pressing wedge

22 longitudinal axis (interconnection web)

1. Stator comprising at least one insulation disk, at least one interconnection web, and at least one temperature sensor, where
said insulation disk comprises a holding element and said interconnection web comprises an abutment surface for said temperature sensor,
said interconnection web and said temperature sensor are arranged and held at least in sections in said holding element and
said temperature sensor touches said abutment surface at least in part in a planar manner and is pressed against said abutment surface by a spring force or by a clamping force.

2. Stator according to claim 1, wherein said holding element is U-shaped in cross section with a base, a first side wall, and a second side wall between which said interconnection web and said temperature sensor are arranged.

3. Stator according to claim 2, wherein said interconnection web is supported directly or indirectly on said first side wall, and said temperature sensor is supported directly or indirectly on said second side wall.

4. Stator according to claim 2, wherein said base or a side wall comprises a spacer for said temperature sensor.

5. Stator according to claim 1, wherein said second side wall or said interconnection web is resiliently deformable.

6. Stator according to claim 5, wherein the distance in cross section of said holding element between said second side wall and said interconnection web prior to the installation of said temperature sensor is smaller than the width of said temperature sensor.

7. Stator according to claim 1, wherein said second side wall has a retaining profile for said temperature sensor.

8. Stator according to claim 1, wherein at least one spring is arranged between said second side wall and said temperature sensor and presses said temperature sensor against said interconnection web.

9. Stator according to claim 1, wherein at least one movable pressing element is integrated into said second side wall and is acted upon by a force in the direction of said temperature sensor.

10. Stator according to claim 1, wherein said second side wall is formed to be wedge-shaped.

11. Stator according to claim 10, wherein said second side wall abuts directly against said temperature sensor.

12. Stator according to claim 10, wherein a pressing wedge is arranged between said second side wall and said temperature sensor.

13. Electric machine with a stator according to claim 1.

14. Stator according to claim 1, wherein said temperature sensor is pressed against said abutment surface by a spring force and by a clamping force.

15. Stator according to claim 2, wherein said base and a side wall comprises a spacer for said temperature sensor.

16. Stator according to claim 3, wherein said base or a side wall comprises a spacer for said temperature sensor.

17. Stator according to claim 3, wherein said base and a side wall comprises a spacer for said temperature sensor.

18. Stator according to claim 1, wherein said second side wall and said interconnection web is resiliently deformable.

19. Stator according to claim 18, wherein the distance in cross section of said holding element between said second side wall and said interconnection web prior to the installation of said temperature sensor is smaller than the width of said temperature sensor.

20. Stator according to claim 19, wherein said second side wall has a retaining profile for said temperature sensor.
